(19) United States
(12) Patent Application Publication
(10) Pub. No.: US 2017/0034245 A1
(43) Pub. Date: Feb. 2, 2017

(54) TRANSFERRING DEVICE AND TRANSFERRING SYSTEM

(71) Applicant: YAHOO JAPAN CORPORATION, Tokyo (JP)

(72) Inventor: Shunsaku ASANO, Tokyo (JP)

(73) Assignee: YAHOO JAPAN CORPORATION, Tokyo (JP)

(21) Appl. No.: 15/202,014

(22) Filed: Jul. 5, 2016

(30) Foreign Application Priority Data
Jul. 29, 2015 (JP) 2015-149874

(51) Int. Cl. H04L 29/08; G06Q 30/02

(52) U.S. Cl. CPC H04L 67/025; H04L 67/18; G06Q 30/0277

(57) ABSTRACT

A transferring device according to the present invention includes a receiving unit, a generating unit, and a transferring unit. The receiving unit receives, from a terminal device, an access request including identification information for identifying content that the terminal devices requests to access. The generating unit generates signature information from the identification information received by the receiving unit using a certain algorithm. The transferring unit instructs the terminal device to transmit an access request including the signature information to a different transferring device judging the validity of the transferring device based on the algorithm and the signature information.

### CROSS-REFERENCE TO RELATED APPLICATION(S)

The present application claims priority to and incorporates by reference the entire contents of Japanese Patent Application No. 2015-149874 filed in Japan on Jul. 29, 2015.

### BACKGROUND OF THE INVENTION

1. Field of the Invention

The present invention relates to a transferring device and a transferring system.

2. Description of the Related Art

With widespread use of the Internet, advertisements are nowadays quite often distributed through the internet. For example, advertisement content to advertise a company, a commodity, and others is displayed on a certain position of a web page. In response to a click on the advertisement content, the user terminal accesses a page (which is referred to as a landing page) linked with the advertisement content through a certain transferring device (which is mentioned as a redirector). A conventional method is described in Japanese Translation of PCT Application No. 2014-517414.

For example, with a redirector transferring (redirecting) a user terminal from the advertisement content to a landing page, redirecting the user terminal from the advertisement content to the landing page is an appropriate behavior. However, if the redirector is an open redirector, which means that the redirector is in a state that can redirect the user terminal to any external page other than the landing page, the redirector may lead the user terminal to a phishing website from the advertisement content upon interference from a third person.

In order to resolve the vulnerability of an open redirector, the redirector performs such processing that judges whether a signature generated from the URL of the landing page by the advertisement server matches a signature generated by the redirector and allows the user terminal to access the landing page only when the signatures match each other.

A system of multistage redirection will now be considered that redirects a user terminal to a web page via a plurality of redirectors managed by respective different administrators. In this case, each redirector generates a signature using its own algorithm. Provided that an administrator G1 manages an advertisement server and a first-stage redirector and an administrator G2 manages a second-stage redirector, the administrator G1 implements a generating algorithm owned by the redirector of the administrator G2 in the advertisement server of the own company. This method increases the load of implementing algorithms with an increase in the number of advertisement servers owned, which is thus unrealistic.

### SUMMARY OF THE INVENTION

It is an object of the present invention to at least partially solve the problems in the conventional technology.

According to one aspect of an embodiment, a transferring device includes a receiving unit that receives, from a terminal device, an access request including identification information for identifying content that the terminal device requests to access. The transferring device includes a generating unit that generates signature information from the identification information received by the receiving unit using a certain algorithm. The transferring device includes a transferring unit that instructs the terminal device to transmit an access request including the signature information to a different transferring device judging validity of the transferring device based on the algorithm and the signature information.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a drawing that illustrates an example of redirecting processing according to an embodiment;

FIG. 2 is a drawing that illustrates an example of redirecting processing according to the embodiment;

FIG. 3 is a drawing that illustrates an exemplary configuration of a redirector 200 according to the embodiment;

FIG. 4 is a drawing that illustrates an exemplary configuration of a redirector 300 according to the embodiment;

FIG. 5 is a sequential drawing that illustrates an example of a transferring processing procedure performed by a transferring system 1 according to the embodiment;

FIG. 6 is a drawing that illustrates an example of redirecting processing according to a modification; and

FIG. 7 is a drawing that illustrates a hardware configuration of an exemplary computer implementing a function of a transferring device.

### DETAILED DESCRIPTION OF THE PREFERRED EMBODIMENTS

An embodiment to implement a transferring device and a transferring system according to the present invention will now be described in detail with reference to the accompanying drawings. It should be noted that the embodiment is not intended to limit the transferring device and the transferring system according to the present invention.

1-1. Redirecting Processing (1)

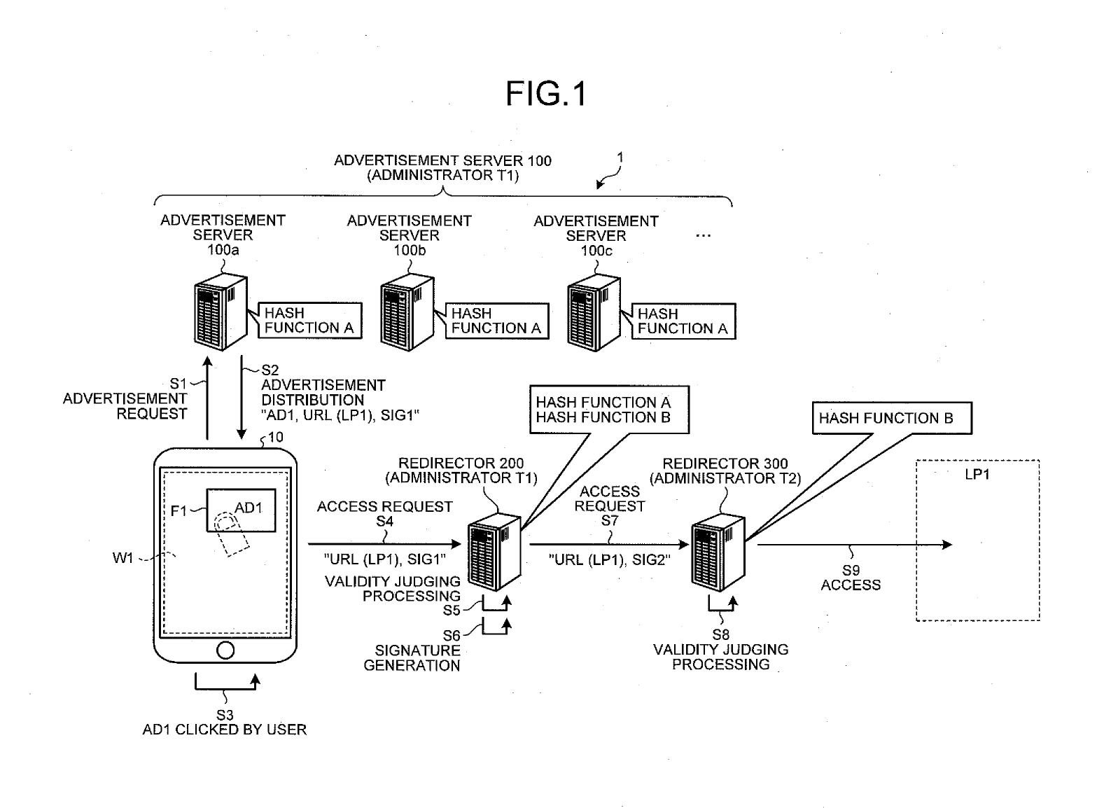

The redirecting processing according to the embodiment will now be described with reference to FIG. 1. FIG. 1 is a drawing that illustrates an example of the redirecting processing according to the embodiment. A transferring system 1 illustrated in FIG. 1 includes a user terminal 10, an advertisement server 100, a redirector 200, and a redirector 300. The user terminal 10, the advertisement server 100, the redirector 200, and the redirector 300 are communicably connected with one another through a network with wired or wireless communication.

The transferring system 1 illustrated in FIG. 1 includes at least three advertisement servers such as advertisement servers 100a, 100b, and 100c; however, the embodiment is not limited to this number of advertisement servers. In the example of FIG. 1, the advertisement servers 100a to 100c are managed by an administrator T1.

Each of the advertisement servers 100a to 100c performs processing of distributing stored advertisement content and further generates a signature from the URL of a landing page associated with stored advertisement content using a hash function A.

The hash function A is one of algorithms to generate a signature. Each of the advertisement servers 100a to 100c generates a signature by applying the URL and the like of a landing page to the hash function A.

The timing when the advertisement servers 100a to 100c perform the signature generating processing may be appropriately determined. For example, each of the advertisement servers 100a to 100c may preliminarily generate a signature for each of the stored URLs before distributing the advertisement. In another way, after determining advertisement content to be distributed in response to an advertisement request from the user terminal 10, the advertisement servers 100a to 100c may generate a signature for the URL of a landing page associated with the advertisement content determined to be distributed. In this embodiment, the advertisement servers 100a to 100c preliminarily generate a signature for each stored URL.

The transferring system 1 illustrated in FIG. 1 includes two redirectors such as the redirector 200 and the redirector 300. In this embodiment, such a two-stage redirecting method is applied that redirects the user terminal 10 to a certain web page via each of the redirectors.

The redirector 200 corresponds to a first-stage redirector in the multistage redirection. The redirector 200 is managed by the administrator T1 that also manages the advertisement server 100. The redirector 200 judges the validity of the advertisement server 100 using the hash function A and generates a signature using a hash function B with a generating algorithm different from that of the hash function A.

The redirector 300 corresponds to a second-stage redirector in the multistage redirection. The redirector 300 is managed by an administrator T2 different from the administrator T1. The redirector 300 judges the validity of the redirector 200 using the hash function B. The redirecting processing of the system 1 will now be described in detail.

The user terminal 10 transmits an advertisement request, which is a request for advertisement content displayed in an advertisement frame F1 for displaying advertisement content on a web page W1, to the advertisement server 100a (Step S1), when the advertisement frame F1 is included. In response to the advertisement request, the advertisement server 100a determines that the advertisement content AD1 is advertisement content to be distributed.

The advertisement server 100a has preliminarily generated a signature from the URL of a landing page associated with the advertisement content AD1 using the hash function A. The URL of a landing page LP1 associated with the advertisement content AD1 is conceptually denoted as “URL (LP1)”, whereas the signature generated from the URL (LP1) is conceptually denoted as “SIG1”. URLs and signatures of other advertisement content may be conceptually denoted in a similar manner.

The advertisement server 100a distributes “SIG1” together with the advertisement content AD1 carrying “URL (LP1)” as a hyperlink destination, to the user terminal 10. The user terminal 10 displays the advertisement content AD1 received from the advertisement server 100a on the advertisement frame F1 (Step S2).

When the advertisement content AD1 is clicked by a user (Step S3), the user terminal 10 transmits an access request including “URL (LP1), SIG1” to the redirector 200 as a request to access the landing page LP1 (Step S4).

The redirector 200 receives the access request including the “URL (LP1), SIG1” and judges the validity of the advertisement server 100a (Step S5). Specifically, similarly to the advertisement server 100a, the redirector 200 generates a signature from the “URL (LP1)” using the hash function A and judges the advertisement server 100a to be valid if the generated signature matches “SIG1”.

The hash function A as a generating algorithm is information exclusively known by the advertisement servers 100 and the redirector 200 as illustrated in FIG. 1. Because “SIG1” can be generated only from the hash function A, if the signature generated by the redirector 200 matches “SIG1”, the redirector 200 can judge the advertisement server 100a to be reliable and valid based on the fact that the advertisement server 100a has the hash function A.

In the event of no match with the signature generated by the redirector 200, the redirector 200 judges the advertisement server 100a to be an unreliable device not having the hash function A.

If the redirector 200 judges the advertisement server 100a to be a valid device, the redirector 200 generates, from the “URL (LP1)”, “SIG2” different from “SIG1” using the hash function B that is provided from the administrator T2 and is an algorithm different from the hash function A (Step S6).

The redirector 200 then instructs the user terminal 10 to transmit an access request including “URL (LP1), SIG2” as a request to access the landing page LP1, to the redirector 300. Upon receipt of the instruction, the user terminal 10 transmits the access request including the “URL (LP1), SIG2” to the redirector 300 (Step S7).

The redirector 300 receives the access request including the “URL (LP1), SIG2” and judges the validity of the redirector 200 (Step S8). Specifically, the redirector 300 generates a signature from the “URL (LP1)” using the hash function B as a generating algorithm provided by the administrator T2 managing the redirector 300 and judges the redirector 200 to be valid if the generated signature matches “SIG2”.

The hash function B as a generating algorithm is information exclusively known by the redirector 200 and the redirector 300 as illustrated in FIG. 1. Because “SIG2” can be generated only from the hash function B, if the signature generated by the redirector 300 matches “SIG2”, the redirector 300 can judge the redirector 200 to be reliable and valid based on the fact that redirector 200 has the hash function B.

In the event of no match with the signature generated by the redirector 300, the redirector 300 judges the redirector 200 to be an unreliable device not having the hash function B.

If the redirector 300 judges the redirector 200 to be a valid device, the redirector 300 instructs the user terminal 10 to access the “URL (LP1)”. Upon receipt of the instruction, the user terminal 10 accesses the “URL (LP1)” (Step S9).

In the case with a plurality of advertisement servers 100 as illustrated in FIG. 1, a generating algorithm based on the hash function A needs to be preliminarily implemented in all the advertisement servers 100 so that the redirector 200 can judge the validity of an advertisement server 100 distributing the advertisement from among all the advertisement servers 100. In this case, the advertisement servers 100 and the redirector 200 are managed by the same administrator T1. Implementing such a generating algorithm in all the advertisement servers 100 is thus a possible operation.

Likewise, with the multistage redirection, a generating algorithm based on the hash function B needs to be preliminarily implemented in all the advertisement servers 100 so that the redirector 300 managed by the administrator T2 can also judge the validity of an advertisement server 100 distributing the advertisement from among all the advertisement servers 100. In this case, however, implementing the generating algorithm owned by the administrator T2, which belongs to a company different from the administrator T1, in all the advertisement servers 100 of the administrator T1 is not a realistic operation. Implementation of the algorithms is more difficult with an increase in the number of the advertisement servers 100.

As illustrated in FIG. 1, with the transferring system 1 according to the embodiment, the redirector 200 implements therein the generating algorithm (the hash function B) of the administrator T2 and generates a signature from the URL of a web page that the user terminal 10 requests to access using the hash function B. When the redirector 300 receives the signature generated by the redirector 200, the redirector 300 generates a signature from the URL using the hash function B implemented by the administrator T2 managing the redirector 300 and judges the validity of the redirector 200 based on the result of matching of the signature generated from the URL and the signature generated by the redirector 200.

The transferring system 1 exerts such advantageous effects that the administrator T1 has no necessity to implement the generating algorithm of the administrator T2, which belongs to another company, in all the advertisement servers 100 and only needs to implement the generating algorithm of the administrator T2 in the redirector 200. This structure can achieve highly versatile signature generation in a transferring system including redirectors of a plurality of administrators.

1-2. Redirecting Processing (2)

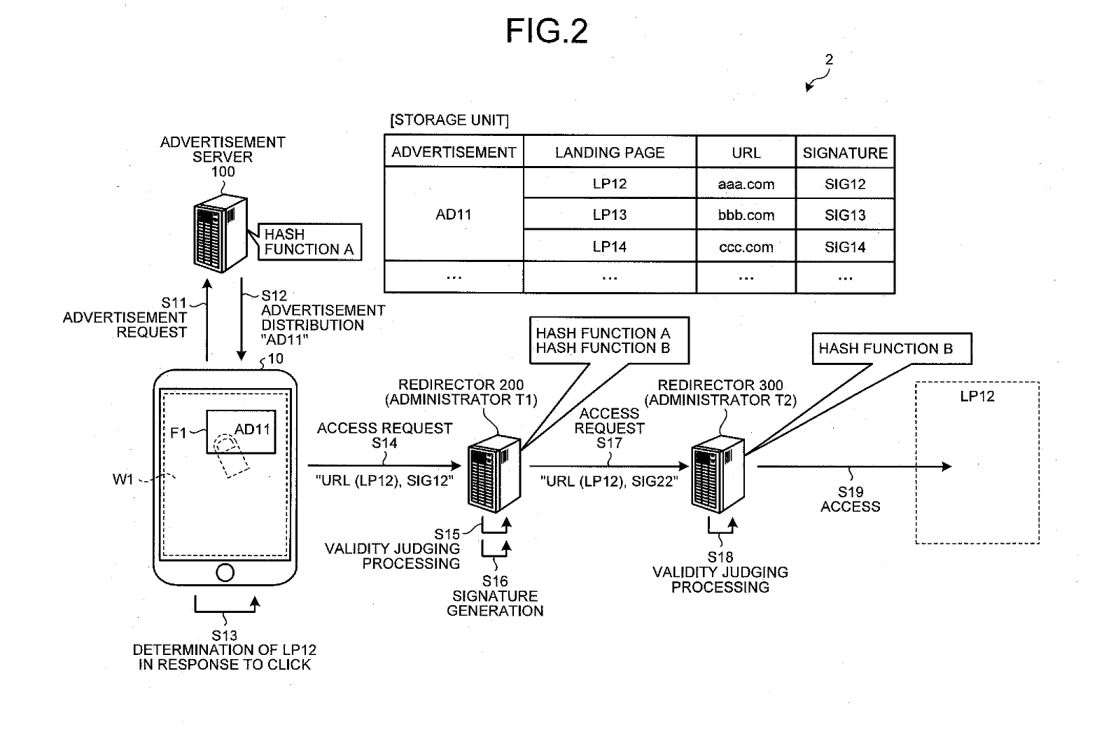

The transferring system 1 including a plurality of advertisement servers 100 has been described with reference to FIG. 1. A transferring system 2 in which a plurality of landing pages are associated with a piece of advertisement content will now be described with reference to FIG. 2.

FIG. 2 is a drawing that illustrates an example of redirecting processing according to the embodiment. The transferring system 2 illustrated in FIG. 2 includes the user terminal 10, the advertisement server 100, the redirector 200, and the redirector 300. The user terminal 10, the advertisement server 100, the redirector 200, and the redirector 300 are communicably connected with one another through a network with wired or wireless communication.

The transferring system 2 also performs two-stage redirection using the redirector 200 and the redirector 300. The redirector 200 and the redirector 300 have been described with reference to FIG. 1, and detailed description will be thus omitted.

In the example of FIG. 1, a piece of advertisement content is associated with a landing page (such as the landing page LP1 for the advertisement content AD1), whereas, in FIG. 2, the advertisement content AD11 is associated with three landing pages including landing pages LP12, LP13, and LP14 as illustrated in the example of a storage unit of the advertisement server 100.

In this case, a certain condition is applied for the advertisement area in the advertisement frame F1. Displayed landing pages are changed depending on which point in the advertisement area in the advertisement frame F1 the user clicks. In other words, the landing page to be displayed is determined only when the user clicks a certain point.

In the example of FIG. 2, the user terminal 10 transmits an advertisement request to the advertisement server 100 (Step S11), and the advertisement server 100 accordingly determines the advertisement content AD11 to be distributed. The advertisement server 100 thereafter transmits, to the user terminal 10 together with the advertisement content AD11, URLs “URL (LP12)”, “URL (LP13)”, and “URL (LP14)” of respective landing pages L12, L13, and L14, which are associated with the advertisement content AD11, and signatures “SIG12”, “SIG13”, and “SIG14” preliminarily generated from the respective URLs using the hash function A (Step S12).

With this process, the user terminal 10 displays the advertisement content AD11 in the advertisement frame F1. The landing pages are set to be changed depending on which point in the advertisement area in the advertisement frame F1 the user clicks.

Assume an example in which, as illustrated in FIG. 2, the landing page LP12 of the above-described three landing pages is determined to be displayed in response to a user's click on the left lower part in the advertisement frame F1 (Step S13).

In this case, the user terminal 10 transmits an access request including “URL (LP12), SIG12” to the redirector 200 as a request to access the landing page L12 (Step S14).

The redirector 200 receives the access request including the “URL (LP12), SIG12” and judges the validity of the advertisement server 100 (Step S15). Specifically, the redirector 200 generates a signature from the “URL (LP12)” using the hash function A and judges the advertisement server 100 to be valid if the generated signature matches “SIG12”.

If the redirector 200 judges the advertisement server 100 to be a valid device, the redirector 200 generates “SIG22” different from “SIG12” from the “URL (LP12)” using the hash function B that is provided by the administrator T2 and is an algorithm different from the hash function A (Step S16).

The redirector 200 then instructs the user terminal 10 to transmit an access request including “URL (LP12), SIG22” as a request to access the landing page L12, to the redirector 300. Upon receipt of the instruction, the user terminal 10 transmits the access request including the “URL (LP12), SIG22” to the redirector 300 (Step S17).

The redirector 300 receives the access request including the “URL (LP12), SIG22” and judges the validity of the redirector 200 (Step S18). Specifically, the redirector 300 generates a signature from the “URL (LP12)” using the hash function B as a generating algorithm provided by the administrator T2 managing the redirector 300 and judges the redirector 200 to be valid if the generated signature matches “SIG22”.

If the redirector 300 judges the redirector 200 to be a valid device, the redirector 300 instructs the user terminal 10 to access the “URL (LP12)”. Upon receipt of the instruction, the user terminal 10 accesses the “URL (LP12)” (Step S19).

As illustrated in FIG. 1, if the landing page to be distributed is not determined until the user clicks a certain point, in order to have the redirector 200 judge the validity of the advertisement server 100, the advertisement server 100 needs to preliminarily generate signatures for the URLs of landing pages associated with respective pieces of stored advertisement content or needs to generate, at a timing when the advertisement server 100 determines advertisement content to be distributed, a signature for the URL of a landing page associated with the determined advertisement content. In this case, the load of the advertisement server 100 in generating signatures increases with an increase in the number of landing pages.

With multistage redirection, in order to also have the redirector 300 of the administrator T2 judge the validity of the advertisement server 100, the advertisement server 100 further needs to generate a signature for each landing page using an algorithm based on the hash function B in addition to an algorithm based on the hash function A. This structure further increases the load on the advertisement server 100 with an increase in the number of landing pages. The load affects the processing speed and the like of the advertisement server 100, which the administrator T1 may desire to prevent.

As illustrated in FIG. 2, with the transferring system 2 according to the embodiment, by having the redirector 200 implement therein the generating algorithm (the hash function B) of the administrator T2, the redirector 200 generates a signature from the URL of a web page that the user terminal 10 requests to access, using the hash function B. When the redirector 300 receives the signature generated by the redirector 200, the redirector 300 generates a signature from the URL using the hash function B implemented by the administrator T2 managing the redirector 300 and judges the validity of the redirector 200 based on the result of matching of the signature generated from the URL and the signature generated by the redirector 200.

With the transferring system 2, the advertisement server 100 has no necessity to generate a signature using the hash function B before distribution of an advertisement. Instead, after distribution of the advertisement and determination of the landing page, the redirector 200 generates a signature using the hash function B for the determined landing page, which can achieve more efficient signature generation.

2-1. Configuration of a Transferring Device (the Redirector 200)

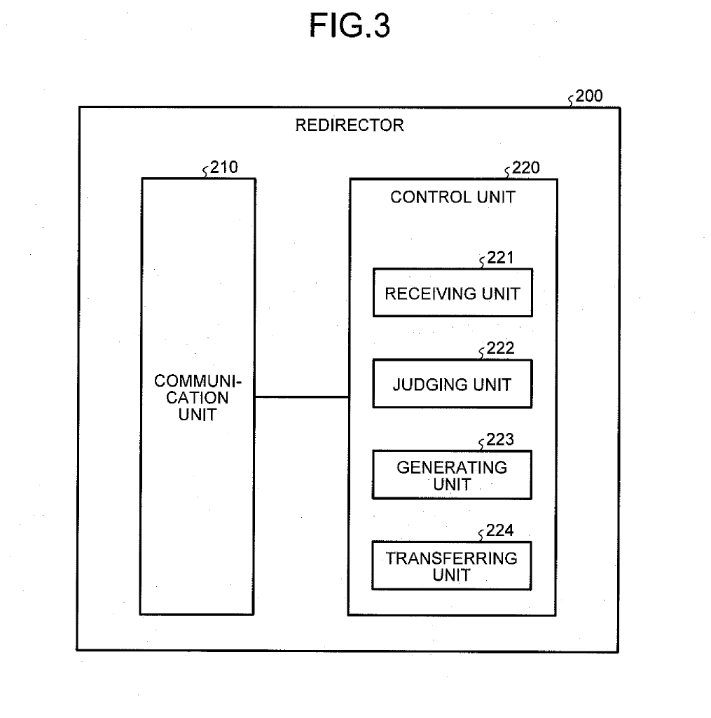

The redirector 200 serving as a transferring device will be described with reference to FIG. 3. FIG. 3 is a drawing that illustrates an exemplary configuration of the redirector 200 according to the embodiment. As illustrated in FIGS. 1 and 2, in the transferring system with the multistage redirection in this embodiment, the redirector 200 corresponds to the first-stage redirector. The redirector 200 is managed by the administrator T1 managing the advertisement server 100 and has the algorithm α and the algorithm β for generating signatures. As illustrated in FIG. 3, the redirector 200 includes a communication unit 210 and a control unit 220.

The communication unit 210 is implemented by, for example, a network interface card (NIC). The communication unit 210 is connected to a network with wired or wireless communication and receives and transmits information from and to the user terminal 10, the advertisement server 100, the redirector 300, and others.

The control unit 220 is implemented by a central processing unit (CPU), a micro processing unit (MPU), and the like in such a manner that a program (which corresponds to an example of a transferring program) stored in an internal storage device is executed with an internal memory such as a random access memory (RAM) serving as a workspace.

As illustrated in FIG. 3, the control unit 220 includes a receiving unit 221, a judging unit 222, a generating unit 223, and a transferring unit 224.

The receiving unit 221 receives an access request including the URL of content (for example, a landing page) that the user terminal 10 requests to access, from the user terminal 10. Specifically, the receiving unit 221 receives an access request to access the content provided from a server device managed by the administrator managing the redirector 200.

More specifically, the receiving unit 221 receives, from the user terminal 10, an access request to access a landing page associated with the advertisement content distributed from the advertisement server 100 managed by the administrator T1.

In the example of FIG. 1, the receiving unit 221 receives an access request from the user terminal 10 that includes the URL of the landing page LP1 associated with the advertisement content AD1 and a signature generated by the advertisement server 100a using the hash function A.

The judging unit 222 judges the validity of the advertisement server 100a. Specifically, the judging unit 222 generates a signature from the URL included in the access request received by the receiving unit 221 using the hash function A included in the generating algorithm α owned by the advertisement server 100a. The judging unit 222 then judges the validity of the advertisement server 100 based on the result of matching of the generated signature and the signature included in the access request. An example of the judging processing of the judging unit 222 will now be described.

For example, as illustrated in FIG. 1, in response to a click of a user on the advertisement content AD1, the receiving unit 221 receives the URL “abc.com” of the landing page LP1 associated with the advertisement content AD1 and a signature “ab25Dxx” generated by the advertisement server 100a from the “abc.com” using the hash function A.

When the receiving unit 221 receives the URL, the judging unit 222 generates a signature from the “abc.com” using an algorithm. Specifically, the judging unit 222 generates a signature by applying the “abc.com” to the hash function A included in the algorithm α. If the generated signature matches the signature “ab25Dxx” generated by the advertisement server 100a, the judging unit 222 judges the advertisement server 100a to be a valid device.

The generating unit 223 generates a signature from the URL received by the receiving unit 221 using an algorithm β different from the algorithm α. Specifically, if the judging unit 222 judges that the server device serving as a distributor of the content is a valid device, the generating unit 223 generates a signature from the URL received by the receiving unit 221 using the algorithm β provided from the administrator T2 different from the administrator T1 managing the redirector 200. An example of the signature generating processing of the generating unit 223 will now be described.

In this case, as illustrated in FIG. 1, the algorithm β used by the generating unit 223 includes the hash function B and further includes a passphrase generating logic B1. It is assumed that the receiving unit 221 has received the URL “abc.com” of the landing page LP1 as described above, and the judging unit 222 has judged the advertisement server 100a to be a valid device.

Upon judgement of the judging unit 222 that the advertisement server 100a is valid, the generating unit 223 generates a hash value by applying the “abc.com” to the hash function B. The hash value corresponds to a signature, and the generating unit 223 generates a signature “cd36Dxy”.

The generating unit 223 further generates a passphrase using the passphrase generating logic B1. The generating unit 223 generates a passphrase “AA12bb34CC”. Furthermore, the generating unit 223 encrypts the signature “cd36Dxy” using the passphrase “AA12bb34CC”.

The transferring unit 224 instructs the user terminal 10 to transmit an access request including the signature generated by the generating unit 223, to the redirector 300 judging the validity of the redirector 200 using the algorithm β. For example, according to the above-described example, the generating unit 223 generates the signature “cd36Dxy” from the URL “abc.com” of the landing page LP1 using the generating algorithm β provided from the administrator T2 of the redirector 300. In this case, with the transferring system performing multistage redirection, the transferring unit 224 instructs the user terminal 10 to transmit the URL “abc.com”, the signature “cd36Dxy”, and the passphrase “AA12bb34CC” to the redirector 300 judging the validity of the redirector 200.

In response to the instruction, the user terminal 10 transmits the URL “abc.com”, the signature “cd36Dxy”, and the passphrase “AA12bb34CC” to the redirector 300.

2-2. Configuration of Another Transferring Device (the Redirector 300)

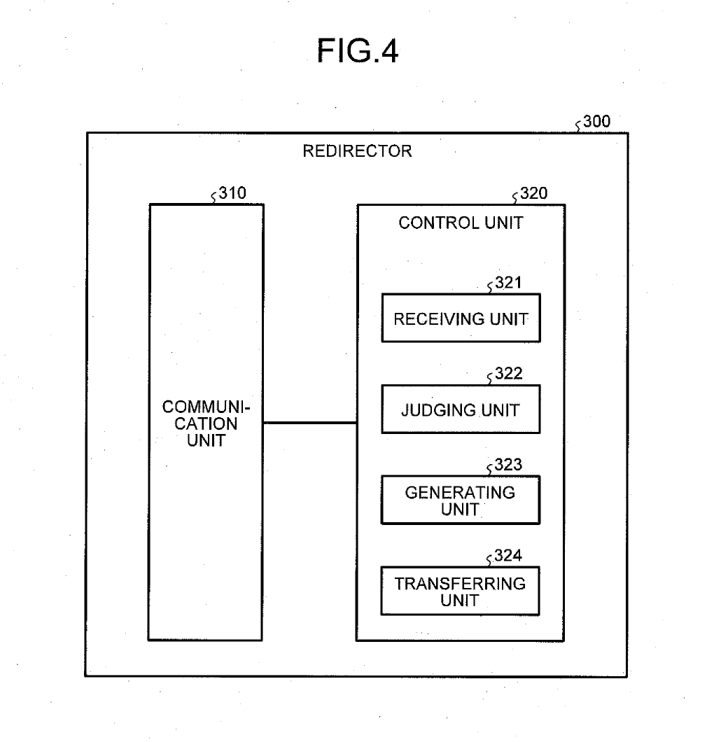

The redirector 300 serving as a transferring device will be described with reference to FIG. 4. FIG. 4 is a drawing that illustrates an exemplary configuration of the redirector 300 according to the embodiment. As illustrated in FIG. 1, the redirector 300 is managed by the administrator T2 and has the redirector 300's own generating algorithm β. FIG. 4 is a drawing that illustrates an exemplary configuration of the redirector 300 according to the embodiment. As illustrated in FIG. 4, the redirector 300 includes a communication unit 310 and a control unit 320.

The communication unit 310 is implemented by, for example, a network interface card (NIC). The communication unit 310 is connected to a network with wired or wireless communication and receives and transmits information from and to the redirector 200 and others.

The control unit 320 is implemented by a CPU, an MPU, and the like in such a manner that a program (which corresponds to an example of a transferring program) stored in an internal storage device is executed with an internal memory such as a RAM serving as a workspace.

As illustrated in FIG. 4, the control unit 320 includes a receiving unit 321, a judging unit 322, a generating unit 323, and a transferring unit 324.

The receiving unit 321 receives an access request from the user terminal 10 that includes the URL of the content requested to be accessed (such as a landing page) and a signature generated by the redirector 200 instructing the user terminal 10 to access the redirector 300.

For example, as described above, in response to a click of the user on the advertisement content AD1, the user terminal 10 requests to access the URL “abc.com”. The redirector 200 accordingly generates the signature “cd36Dxy” and the passphrase “AA12bb34CC”. The transferring unit 224 performs the above-described redirecting processing, and the receiving unit 321 accordingly receives these pieces of information from the user terminal 10.

When the receiving unit 321 receives the access request including the URL and the signature, the judging unit 322 judges the validity of the redirector 200 serving as the first-stage redirector. Specifically, the judging unit 322 generates a signature from the URL included in the access request received by the receiving unit 321 using the hash function B included in the algorithm β. The judging unit 322 thereafter judges the validity of the redirector 200 based on the result of matching of the generated signature and the signature included in the access request.

According to the above-described example, the receiving unit 321 receives the URL “abc.com” of the landing page LP1, the signature “cd36Dxy”, and the passphrase “AA12bb34CC” generated by the generating unit 223 of the redirector 200.

When the receiving unit 321 receives these pieces of information, the judging unit 322 decrypts the encrypted signature “cd36Dxy” using the passphrase “AA12bb34CC”. The judging unit 322 generates a signature by applying the “abc.com” to the hash function B included in the generating algorithm β. The judging unit 322 judges the redirector 200 to be a valid device if the generated signature matches the signature “cd36Dxy” generated by the generating unit 223 of the redirector 200.

The generating unit 323 is a unit used in the later-described multistage request with three or more stages. Because the generating unit 323 is not used in the two-stage request described in this embodiment, detailed description will be omitted.

If the judging unit 322 judges the redirector 200 to be valid, the transferring unit 324 instructs the user terminal 10 to access the content that the user terminal 10 is requesting to access. If, as illustrated in FIG. 1, the user terminal 10 makes a request to access the landing page LP1 and the judging unit 322 judges the redirector 200 to be valid as described above, the transferring unit 324 instructs the user terminal 10 to access the URL “abc.com” of the landing page LP1.

3. Procedure of Processing

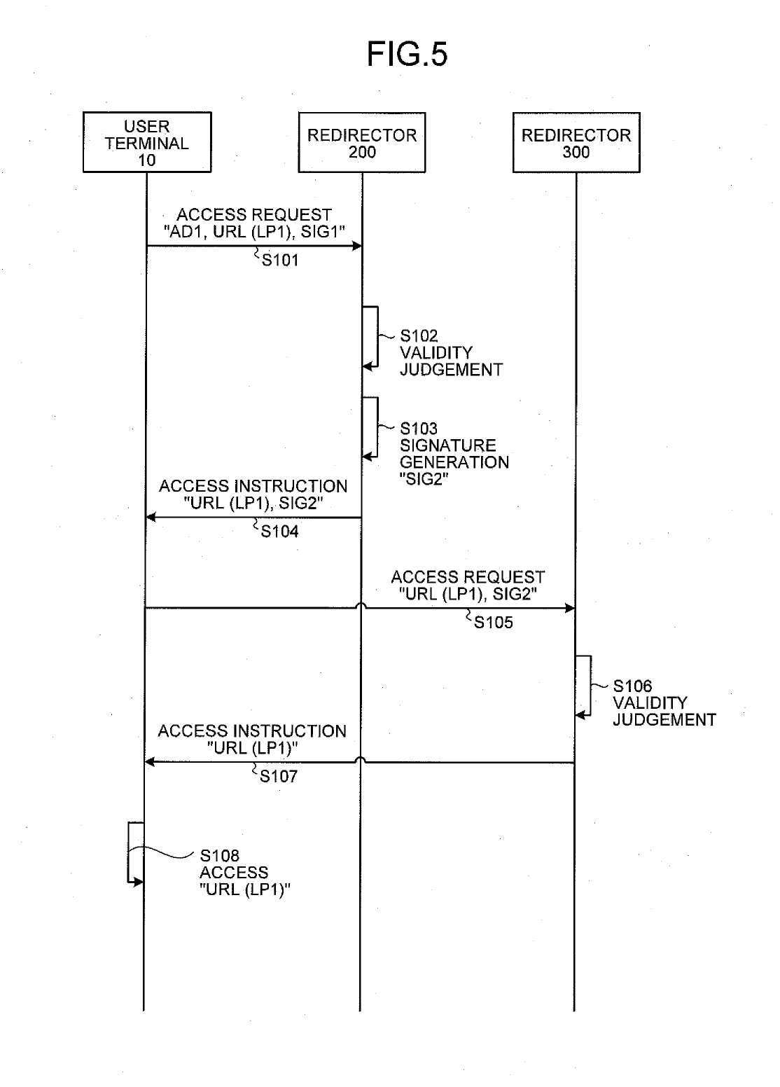

The transferring processing procedure according to the embodiment will now be described with reference to FIG. 5. FIG. 5 is a sequential drawing that illustrates an example of the transferring processing procedure performed by the transferring system 1 according to the embodiment. The transferring system 1 performs two-stage redirection to redirect the user terminal 10 to a certain web page via the redirector 200 and the redirector 300.

The advertisement server 100 preliminarily generates a signature from the URL of a landing page associated with each piece of the advertisement content using the hash function A. For example, when a user of the user terminal 10 clicks the advertisement content AD1, then as illustrated in FIG. 5, the user terminal 10 transmits an access request including the URL (LP1), which is the URL of the landing page LP1, and the signature “SIG1” generated from the URL, to the redirector 200 as a request to access the landing page LP1 associated with the advertisement content AD1 (Step S101).

The advertisement server 100 and the redirector 200 are managed by the administrator T1 and have its own algorithm α. The redirector 200 further owns the algorithm β provided by the administrator T2 managing the redirector 300. The algorithm β is an algorithm specific to the redirector 300 and is different from the algorithm α.

When the receiving unit 221 of the redirector 200 receives “URL (LP1), SIG1”, the judging unit 222 judges the validity of the advertisement server 100 (Step S102). Specifically, the judging unit 222 generates a signature by applying the “URL (LP1)” to the hash function A included in the algorithm α and compares the generated signature with “SIG1”. If the signature matches “SIG1”, the judging unit 221 judges the advertisement server 100 to be a valid device.

The generating unit 223 generates a signature from the “URL (LP1)” using the algorithm β (Step S103). Specifically, the generating unit 223 generates “SIG2”, a signature different from the “SIG1”, by applying the “URL (LP1)” to the hash function B included in the algorithm β. In this process, the generating unit 223 generates a certain passphrase and encrypts the “SIG2” with the generated passphrase.

The transferring unit 224 instructs the user terminal 10 to transmit, to the redirector 300, an access request including the “SIG2” generated by the generating unit 223 and the “URL (LP1)” (Step S104). Upon receipt of the instruction, the user terminal 10 transmits the access request including the “URL (LP1), SIG2” to the redirector 300 (Step S105).

When the receiving unit 321 of the redirector 300 receives the “URL (LP1), SIG2”, the judging unit 322 judges the validity of the redirector 200 (Step S106). Specifically, the judging unit 322 generates a signature by applying the “URL (LP1)” to the hash function B included in the algorithm β and compares the generated signature with the “SIG2”. If the signature matches “SIG2”, the judging unit 321 judges the redirector 200 to be a valid device.

If the redirector 200 is judged to be valid, the transferring unit 324 instructs the user terminal 10 to access the landing page LP1 corresponding to the “URL (LP1)” (Step S107). Upon receipt of the instruction, the user terminal 10 accesses the landing page LP1 (Step S108).

4. Modification

In the above-described transferring system, a redirector may be implemented in various different forms other than the described embodiment. Other embodiments of the redirector will now be described.

4-1. Redirection with Three or More Stages (1)

In the above-described embodiment, such an example has been described that a transferring system including the redirector 200 and the redirector 300 performs two-stage redirection. The transferring system in the embodiment is not necessarily limited to the two-stage redirection. Instead, the transferring system may perform three-stage or four-stage redirection. In the modification, a transferring system 3 performing three-stage redirection will be described.

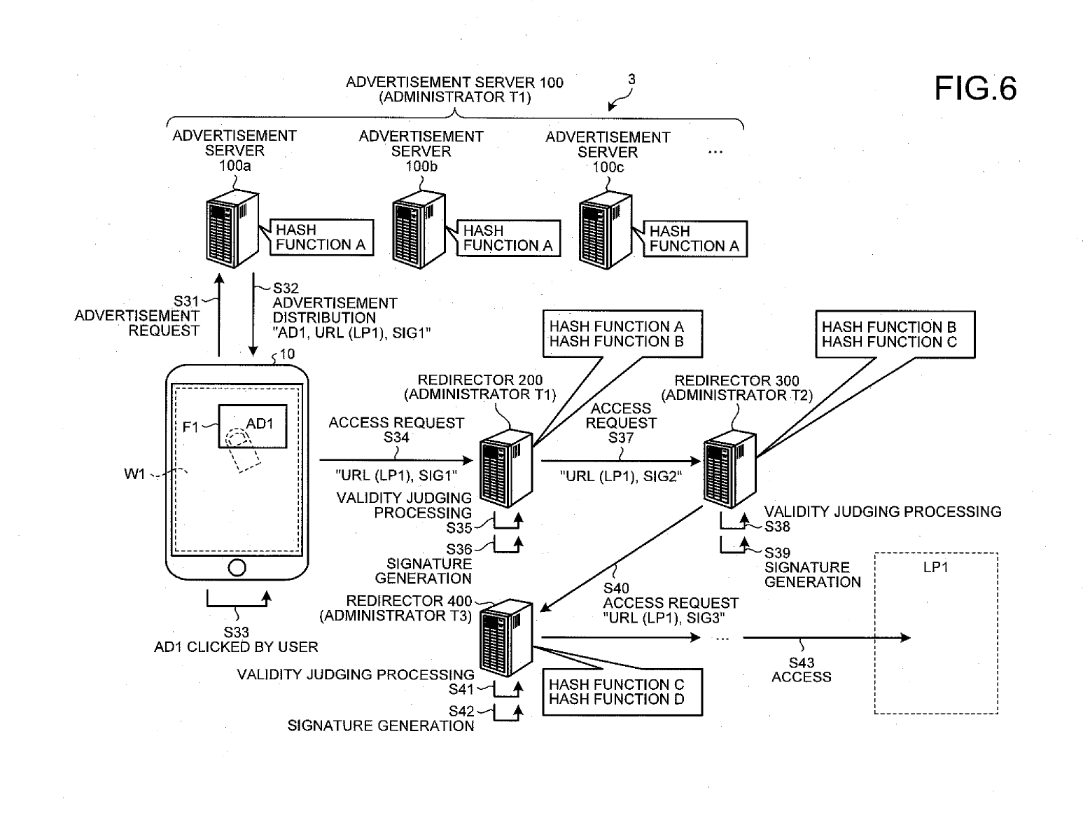

FIG. 6 is a drawing that illustrates an example of redirecting processing according to the modification. The transferring system 3 illustrated in FIG. 6 includes the user terminal 10, the advertisement server 100, the redirector 200, the redirector 300, and a redirector 400. The user terminal 10, the advertisement server 100, the redirector 200, the redirector 300, and the redirector 400 are communicably connected with one another through a network with wired or wireless communication.

In addition to the transferring system 1 illustrated in FIG. 1, the transferring system 3 illustrated in FIG. 6 includes the redirector 400 as a third-stage redirector managed by an administrator T3 different from the administrator T1 or the administrator T2. The redirector 400 owns a specific algorithm γ created by and specific to the administrator T3. The algorithm γ includes a hash function C different from the hash function A or the hash function B.

With this structure, the redirector 300 has the algorithm β and the algorithm γ provided by the administrator T3. Because the redirector 300 has the algorithm γ, the redirector 300 additionally includes the generating unit 323 generating a new signature from the URL received by the receiving unit 321 using the algorithm γ as illustrated in FIG. 4. The redirecting processing of the transferring system 3 will now be described in detail with reference to FIG. 6. Description overlapping with FIG. 1 will be omitted.

The user terminal 10 transmits an advertisement request to the advertisement server 100a (Step S31). In response to the advertisement request, the advertisement server 100a determines that the advertisement content AD1 is advertisement content to be distributed.

The advertisement server 100a distributes a preliminarily generated signature “SIG1” to the user terminal 10 together with the advertisement content AD1 carrying “URL (LP1)”, which is the URL of the landing page LP1, as a hyperlink destination. The user terminal 10 displays the advertisement content AD1 received from the advertisement server 100a, on the advertisement frame F1 (Step S32).

When the advertisement content AD1 is clicked by a user (Step S33), the user terminal 10 transmits an access request including “URL (LP1), SIG1” as a request to access the landing page LP1, to the redirector 200 (Step S34).

When the receiving unit 221 of the redirector 200 receives the access request, the judging unit 222 generates a signature from the “URL (LP1)” using the hash function A and judges the validity of the advertisement server 100a based on the result of matching of the generated signature and “SIG1” (Step S35).

If the judging unit 222 judges the advertisement server 100a to be valid, the generating unit 223 generates another signature “SIG2” different from “SIG1” using the hash function B provided from the administrator T2 of the redirector 300 and generates a passphrase (Step S36). The transferring unit 224 instructs the user terminal 10 to transmit an access request including “URL (LP1), SIG2”, to the redirector 300.

Upon receipt of the instruction, the user terminal 10 transmits the access request including the “URL (LP1), SIG2” to the redirector 300 (Step S37).

When the receiving unit 321 of the redirector 300 receives the access request, the judging unit 322 generates a signature from the “URL (LP1)” using the hash function B specific to the redirector 300 and judges the validity of the redirector 200 based on the result of matching of the generated signature and “SIG2” (Step S38).

If the judging unit 322 judges the redirector 200 to be valid, the generating unit 323 generates another signature “SIG3” different from “SIG1” or “SIG2” using the hash function C provided by the administrator T3 of the redirector 400 and generates a passphrase (Step S39). The transferring unit 324 instructs the user terminal 10 to transmit an access request including “URL (LP1), SIG3” to the redirector 400.

Upon receipt of the instruction, the user terminal 10 transmits the access request including the “URL (LP1), SIG3” to the redirector 400 (Step S40).

Similarly to the redirector 200 and the redirector 300, the redirector 400 has a receiving unit, a judging unit, and a transferring unit, which are not illustrated. In the example of FIG. 6, the redirector 400 is situated at the third position in the three-stage redirection. In the case of having subsequent redirectors in four-stage or five-stage redirection, the redirector 400 further includes a generating unit.

Referring back to FIG. 6, upon receipt of the access request, the redirector 400 generates a signature from the “URL (LP1)” using the hash function C included in the algorithm γ specific to the redirector 400 and judges the validity of the redirector 300 based on the result of matching of the generated signature and “SIG3” (Step S41). The redirector 400 instructs the user terminal 10 to access the landing page LP1 corresponding to the “URL (LP1)”. Upon the instruction, the user terminal 10 accesses the landing page LP1 (Step S43).

For example, if another redirector 500 is included subsequent to the redirector 400, the redirector 400 has an algorithm (such as an algorithm δ including a hash function D) specific to the redirector 500. In this case, the redirector 400 generates a new signature “SIG4” from the “URL (LP1)” using the hash function D (Step S42) and instructs the user terminal to transmit an access request including the generated signature and the “URL (LP1)” to the redirector 500.

In summary, in the case with redirection with three or more stages, which include redirectors managed by respective different administrators, each redirector having an algorithm specific to the next stage redirector may perform the judging processing and the generating processing upon receipt of an access request. With this structure, the administrator T1 does not for example need to implement algorithms of respective administrators in a plurality of advertisement servers 100 owned by the administrator T1, whereby the administrator T1 can easily introduce a redirector of another company into the transferring system.

With this structure, the advertisement server 100 does not need to preliminarily generate a signature for each of the landing pages of a plurality of advertisement content pieces using a corresponding algorithm before distributing an advertisement. Instead, after determination of a landing page, each redirector may only need to generate a signature only for the determined landing page, which is more efficient.

4-2. Redirection with Three or More Stages (2)

In the modification of 4-1, such redirecting processing has been described that each redirector has an algorithm of the next stage redirector and generates a signature for the next stage redirector. In another example, a redirector A may have algorithms of all the redirectors included in the transferring system and generate a signature for each redirector using a corresponding algorithm. This example will now be described in detail.

The transferring system 3 illustrated in FIG. 6 includes the redirectors 200 to 400. The redirector 200 corresponds to a first-stage redirector. The redirector 200 may have the algorithm β for the redirector 300 and the algorithm γ for the redirector 400 together with the algorithm α for the redirector 200.

Assume an example in which the receiving unit 221 of the redirector 200 receives “URL (LP1), SIG1” from the user terminal 10, and the generating unit 223 judges the advertisement server 100a to be a valid device. In this example, the generating unit 223 generates a signature “SIG2” for the redirector 300 and a signature “SIG3” for the redirector 400 from the “URL (LP1)” using the hash function B of the algorithm β and the hash function C of the algorithm γ, respectively. The transferring unit 224 instructs the user terminal 10 to transmit an access request including “URL (LP1), SIG2, SIG3”, to the redirector 300.

The redirector 300, when receiving the “URL (LP1), SIG2, SIG3”, generates a signature from the URL (LP1) using the hash function B of the redirector 300 and judges the validity of the redirector 200 based on the result of matching of the generated signature and “SIG2”. If the redirector 300 judges the redirector 200 to be a valid device, the redirector 300 instructs the user terminal 10 to transmit an access request including “URL (LP1), SIG3”, to the redirector 400.

The redirector 400, when receiving the “URL (LP1), SIG3”, generates a signature from the URL (LP1) using the hash function C of the redirector 400, and judges the validity of the redirector 200 based on the result of matching of the generated signature and “SIG3”. If the redirector 400 judges the redirector 200 to be a valid device, the redirector 400 instructs the user terminal 10 to access the landing page LP1 corresponding to the “URL (LP1)”.

With this structure, the redirector 300 does not need to have the algorithm of the redirector 400. In other words, the administrator T1 does not need to have the administrator T2 implement, in its device, the algorithm γ provided by the administrator T3 of the redirector 400. Instead, the administrator T1 may implement all the algorithms in the redirector 200 of the administrator T1. With this structure, the administrator T1 can more easily introduce a redirector of another company into the transferring system.

4-3. Redirector 200

In the above-described embodiment, such an example has been described that the redirector 200 judges the validity of the advertisement server 100 using the hash function A. However, the redirector 200 does not always need to judge the validity of the advertisement server 100. For example, if the administrator T1 has a security policy that does not consider the validity of the advertisement server 100, the redirector 200 may skip the judgement on the validity of the advertisement server 100 when receiving an access request and immediately generate a signature using the hash function B.

4-4. Signature Generation in the Advertisement Server Side

In the above-described embodiment, each advertisement server 100 has preliminarily generated signatures for landing pages of all pieces of stored advertisement content; alternatively, upon determination of advertisement content to be distributed, the advertisement server 100 has generated a signature for a landing page associated with the determined advertisement content. The timing when the advertisement server generates a signature is not limited to these examples.

For example, the administrator T1 of the advertisement server 100 may provide a client advertiser with a signature generating tool including the algorithm α, and have each advertiser generate a signature. By doing so, the advertisement server 100 receives the signature generated by the advertiser, for example, upon submission of the advertisement content.

Alternatively, the advertisement server 100 may generate a signature upon receipt, from the redirector 200, of a request for generating a signature, instead of preliminarily generating a signature or generating a signature upon determination of advertisement content to be distributed as described above.

Assume an example in which the receiving unit 221 of the redirector 200 receives, from the user terminal, an access request to access the landing page LP1. Because the access request includes no signatures, the receiving unit 221 contacts the advertisement server 100 distributing the advertisement content associated with the landing page LP1, to request a signature.

Upon receipt of the request, the advertisement server 100 generates a signature from the URL of the landing page LP1 using the hash function A and transmits the generated signature to the redirector 200.

4-5. Advertisement Server

In the above-described embodiment, as an example of a content distributing server, the transferring system including advertisement servers has been described. However, the transferring system may include, not limited to an advertisement server, a server device and the like distributing various kinds of web pages.

4-6. Hardware Configuration

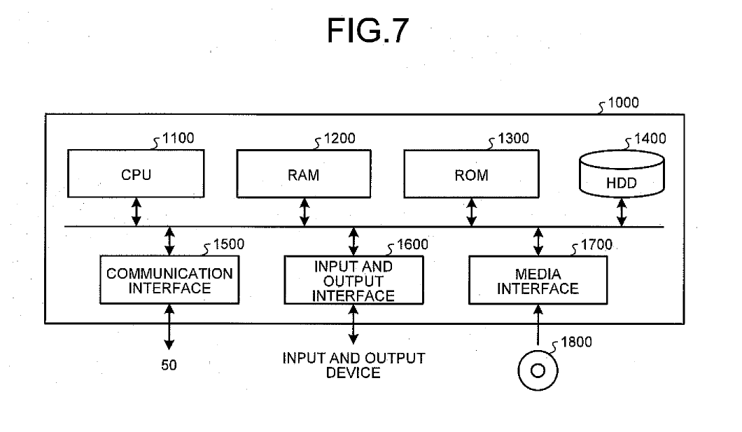

The redirector 200 and the redirector 300 according to the embodiment are implemented by, for example, a computer 1000 with a configuration illustrated in FIG. 7. FIG. 7 is a drawing that illustrates a hardware configuration of an example of the computer 1000 implementing the function of the transferring device (the redirector 200 and the redirector 300). The computer 1000 includes a CPU 1100, a RAM 1200, a ROM 1300, an HDD 1400, a communication interface (I/F) 1500, an input and output interface (I/F) 1600, and a media interface (I/F) 1700.

The CPU 1100 operates in accordance with a computer program stored in the ROM 1300 or the HDD 1400 and controls each unit. The ROM 1300 stores, for example, a boot program executed by the CPU 1100 in booting the computer 1000 and a computer program dependent on the hardware of the computer 1000.

The HDD 1400 stores computer programs executed by the CPU 1100, data used by the programs, and others. The communication interface 1500 receives data from another device via a communication network 50 and transmits the data to the CPU 1100. The communication interface 1500 further transmits data generated by the CPU 1100 to another device via the communication network 50.

The CPU 1100 controls output devices such as a display and a printer and input devices such as a keyboard and mouse through the input and output interface 1600. The CPU 1100 acquires data from the input device through the input and output interface 1600 and outputs generated data to the output device through the input and output interface 1600.

The media interface 1700 reads computer programs or data stored in a recording medium 1800 and provides the programs or data to the CPU 1100 through the RAM 1200. The CPU 1100 loads a computer program into the RAM 1200 from the recording medium 1800 through the media interface 1700 and executes the loaded program. Examples of the recording medium 1800 include an optical recording medium such as a digital versatile disc (DVD), a phase change rewritable disk (PD), a magneto-optical recording medium such as a magneto-optical disk (MO), a tape medium, a magnetic recording medium, and a semiconductor memory.

Provided that the computer 1000 serves as the redirector 200 according to the embodiment, the CPU 1100 of the computer 1000 implements the function of the control unit 220 by executing computer programs loaded into the RAM 1200. The CPU 1100 of the computer 1000 reads the programs out of the recording medium 1800 and executes the programs. In another example, the CPU 1100 may acquire the programs from another device via the communication network 50.

5. Others

In the above-described embodiment, a part of or the whole of processing mentioned to be automatically executed may be manually executed. Conversely, a part of or the whole of processing mentioned to be manually executed may be automatically executed using a known method. Furthermore, any change can be made on processing procedures, specific names, information including various kinds of data and parameters described in the description or illustrated in the drawings if not otherwise specified. Various kinds of information illustrated in the drawings are not limited to the information as illustrated therein.

The components of each illustrated device are merely illustrated in functional and conceptual manners and do not always need to be physically configured as illustrated in the drawings. More specifically, manners in which the devices are separated or integrated are not limited to those illustrated in the drawings. A part of or the whole of the device can be functionally or physically separated or integrated with others in a certain unit according to various kinds of load and usage.

Furthermore, the above-described embodiments can be combined with one another as appropriate without departing from the intent of the processing content.

6. Advantageous Effects

The transferring device (The redirector 200) according to the embodiment includes the receiving unit 221, the generating unit 223, and the transferring unit 224. The receiving unit 221 receives an access request including identification information (URL (LP1)) for identifying the content that the terminal device requests to access from the user terminal. The generating unit 223 generates signature information (SIG2) from the identification information received by the receiving unit 221 using a certain algorithm (the algorithm α). The transferring unit 224 instructs the terminal device to transmit an access request including SIG2 to another transferring device (the redirector 300) judging the validity of the redirector 200 based on the algorithm α and SIG2.

The transferring system including the redirector 200 and the redirector 300 has no necessity to implement the algorithm β of the redirector 300 in a certain server device (the advertisement server 100) and only needs to implement the algorithm β in the redirector 200, which can achieve highly versatile signature generation.

Furthermore, with this structure, the advertisement server 100 has no necessity to generate a signature from the URL of each content piece using the algorithm β. Instead, it is sufficient that the redirector 200 generates a signature only for the determined content, which can achieve highly versatile signature generation.

The receiving unit 221 receives an access request to access the content provided from the server device (the advertisement server 100) managed by the administrator T1 managing the redirector 200. The transferring unit 224 instructs the terminal device to transmit an access request including SIG2 to another transferring device (the redirector 300) managed by the administrator T2 different from the administrator T1.

This kind of transferring system including the redirector 200 and the redirector 300 can achieve highly versatile signature generation.

The transferring device (The redirector 300) according to the embodiment includes the receiving unit 321, the judging unit 322, and the transferring unit 324. The receiving unit 321 receives, from the terminal device, an access request including identification information (URL (LP1)) for identifying the content that the terminal device requests to access and signature information (SIG2) generated from the identification information (URL (LP1)) based on the algorithm β by another transferring device (the redirector 200) that the terminal device has accessed. The judging unit 322 judges the validity of the redirector 200 using SIG2 received by the receiving unit 321 and the algorithm β. If the judging unit 322 judges the redirector 200 to be valid, the transferring unit 324 instructs the terminal device to access the content identified with the identification information.

The transferring system including the redirector 200 and the redirector 300 has no necessity to implement the algorithm β that the redirector 300 has, in a certain server device (the advertisement server 100) and only needs to implement the algorithm β in the redirector 200, which can achieve highly versatile signature generation.

Furthermore, with this structure, the advertisement server 100 has no necessity to generate a signature from the URL of each content piece using the algorithm β. Instead, it is sufficient that the redirector 200 generates a signature only for the determined content, which can achieve highly versatile signature generation.

The redirector 300 further includes the generating unit 323 generating another type of signature information (SIG3) different from the signature information (SIG2) from the identification information (URL (LP1)) received by the receiving unit 321 using another algorithm (the algorithm δ) different from the algorithm β. The transferring unit 324 instructs the terminal device to transmit an access request including SIG3 to another transferring device (the redirector 400) judging the validity of the redirector 300 using the algorithm δ and SIG3.

With the transferring system according to the embodiment, even in the case of performing three or more stage redirection, the administrator T1 has no necessity to implement algorithms of respective different administrators in all the advertisement servers 100 owned by the administrator T1, whereby the administrator T1 can easily introduce a redirector of another company into the transferring system.

Some embodiments of the present invention have been described in detail with reference to the drawings; however, these are merely examples. The present invention can be embodied in another form in which various changes and modifications have been made using knowledge of the skilled person other than the forms described in the summary of the invention.

The word “unit” used in the above description can be replaced by “means” or “circuit”. For example, receiving means and a receiving circuit can replace the receiving unit.

According to an embodiment, versatile signature generation can be achieved.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A transferring device comprising:
a receiving unit that receives, from a terminal device, an access request including identification information for identifying content that the terminal device requests to access;
a generating unit that generates signature information from the identification information received by the receiving unit using a certain algorithm; and
a transferring unit that instructs the terminal device to transmit an access request including the signature information to a different transferring device judging validity of the transferring device based on the algorithm and the signature information.

2. The transferring device according to claim 1, wherein
the receiving unit receives an access request to content provided by a server device managed by a first administrator managing the transferring device, and
the transferring unit instructs the terminal device to transmit an access request including the signature information to the different transferring device managed by a second administrator different from the first administrator.

3. A transferring device comprising;
a receiving unit that receives, from a terminal device, an access request including identification information for identifying content that the terminal device requests to access, and first signature information generated from the identification information based on a first algorithm by a first different transferring device that the terminal device has accessed;
a judging unit that judges validity of the first different transferring device using the first signature information received by the receiving unit and the first algorithm; and
a transferring unit that, when the judging unit judges the first different transferring device to be valid, instructs the terminal device to access the content identified with the identification information.

4. The transferring device according to claim 3, further comprising:
a generating unit that generates second signature information different from the first signature information from the identification information received by the receiving unit using a second algorithm different from the first algorithm, wherein
the transferring unit instructs the terminal device to transmit an access request including the second signature information to a second different transferring device judging the validity of the transferring device based on the second algorithm and the second signature information.

5. A transferring system comprising a first transferring device and a second transferring device,
the first transferring device including:
a first receiving unit that receives, from a terminal device, an access request including identification information for identifying content that the terminal device requests to access;
a generating unit that generates signature information from the identification information received by the first receiving unit using a certain algorithm, and
a first transferring unit that instructs the terminal device to transmit an access request including the signature information to the second transferring device judging validity of the first transferring device based on the algorithm and the signature information, and
the second transferring device including:
a second receiving unit that receives, from the terminal device, the access request including the identification information and the signature information;
a judging unit that judges validity of the first transferring device using the signature information received by the second receiving unit and the algorithm; and
a second transferring unit that, when the judging unit judges the first transferring device to be valid, instructs the terminal device to access the content identified with the identification information.
